(19) United States
(12) Patent Application Publication
(10) Pub. No.: US 2026/0270912 A1
(43) Pub. Date: Sep. 10, 2026

(54) USER EQUIPMENT-INITIATED RANDOM ACCESS CHANNEL FOR LAYER 1/LAYER 2-TRIGGERED MOBILITY

(71) Applicant: Apple Inc., Cupertino, CA (US)

(72) Inventors: Hong He, San Jose, CA (US); Dan Wu, Beijing (CN); Dawei Zhang, Saratoga, CA (US); Wei Zeng, Saratoga, CA (US); Chunxuan Ye, San Diego, CA (US); Jie Cui, San Jose, CA (US)

(73) Assignee: Apple Inc., Cupertino, CA (US)

(21) Appl. No.: 19/165,547

(22) PCT Filed: Mar. 31, 2023
(86) PCT No.: PCT/CN2023/085729

§ 371 Date: Sep. 15, 2025

(51) Int. Cl. H04W 56/00; H04W 36/00; H04W 74/0833

(52) U.S. Cl. CPC H04W 56/0045; H04W 36/0077; H04W 74/0833

(57) ABSTRACT

The present application relates to devices and components including apparatus, systems, and methods to provide user equipment-initiated random access channel for layer 1/layer 2-triggered mobility.

### TECHNICAL FIELD

The present application relates to the field of wireless technologies and, in particular, to user equipment (UE)-initiated random access channel (RACH) for layer 1 (L1)/layer 2 (L2)-triggered mobility (LTM) in a wireless system.

### BACKGROUND

Third Generation Partnership Project (3GPP) networks provide multiple cells that can provide services to user equipments (UEs). Each of the cells may have a corresponding base station that provides the services to the UEs within the cell. As a UE moves through an area serviced by a network, the UE may move in and out of different cells provided by the network. As the UE moves between the cells, the UE may perform procedures to establish connections with the base stations corresponding cells in which the UE is located.

### BRIEF DESCRIPTION OF THE DRAWINGS

FIG. 1 illustrates an example user equipment (UE)-based timing compensation approach representation in accordance with some embodiments.

FIG. 2 illustrates an example non-serving cell-sounding reference signal-resource set (N-SRS-RESET) activation/deactivation for candidate cells arrangement in accordance with some embodiments.

FIG. 3 illustrates an example enhanced downlink control information (DCI) format 2_3 to provide transit power control (TPC) for candidate cells in accordance with some embodiments.

FIG. 4 illustrates an example spatial relation arrangement in accordance with some embodiments.

FIG. 5 illustrates an example medium access control (MAC)-control element (CE) format in accordance with some embodiments.

FIG. 6 illustrates an example procedure of operating a UE in accordance with some embodiments.

FIG. 7 illustrates an example procedure of operating a UE in accordance with some embodiments.

FIG. 8 illustrates an example procedure of operating a base station in accordance with some embodiments.

FIG. 9 illustrates an example procedure of operating a UE in accordance with some embodiments.

FIG. 10 illustrates an example procedure of operating a UE in accordance with some embodiments.

FIG. 11 illustrates an example procedure of operating a base station in accordance with some embodiments.

FIG. 12 illustrates example beamforming circuitry in accordance with some embodiments.

FIG. 13 illustrates an example UE in accordance with some embodiments.

FIG. 14 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

New mobile services that require low-latency and high reliability performance (e.g., ultra-reliable low latency communications (URLLC)) are emerging. While the fifth generation (5G) standard has been designed to address these services from the start, the evolution of 5G New Radio (NR) needs to continuously enhance the mobility robustness performance for these challenging scenarios.

In radio access network (RAN) plenary 94-e Meeting, one Work Item ‘NR mobility enhancements’ was approved with the following objective: layer 1 (L1) enhancements for inter-cell beam management, including L1 measurement and reporting, and beam indication.

In the past RAN work group 1 (RAN1) meeting, a couple of new issues related to Timing Advance (TA) Management associated with candidate cell in L1/layer 2 (L2)-Triggered Mobility (LTM) procedure were identified and approaches are needed to address these issues.

For a first issue, one candidate approach to obtain TA of a non-serving cell is to trigger sounding reference signal (SRS) transmission and TA is computed by network based on the received SRS. So far, SRS transmission is limited to serving cell and active uplink (UL) bandwidth part (BWP). How to enable SRS-based UL timing acquisition for LTM procedure needs to be addressed. Approaches described throughout this disclosure may provide for SRS-based UL timing acquisition for LTM procedures.

For a second issue, generally speaking, compared to network, a user equipment (UE) who performs the measurement has a better knowledge on when to trigger the cell switching such that the latency can be minimized. On the other hand, a UE-initiate random access channel (RACH) procedure needs to avoid the potential physical random access channel (PRACH) collision, handover failure as well as minimize system overhead. Approaches described throughout this disclosure may provide for a UE-initiated RACH procedure that avoids potential PRACH collisions and reduces the chance of handover failure, while minimizing an amount of system overhead utilized for the UE-initiated RACH procedure.

### SRS-Based Uplink Timing Management for Two TAs

According to certain aspects of this disclosure, a variety of approaches may be considered to trigger aperiodic SRS transmission towards the target cell and to derive the TA value by the network. For example, an aperiodic SRS transmission from a UE toward a target cell may be triggered. The UE may transmit the SRS transmission to a base station that operates the target cell. The UE may derive a TA value based on transmissions provided by the network to the UE.

Different options may be considered for the UL transmission timing for SRS towards the target cell. A first option may include using the downlink (DL) timing obtained from the DL reference signal (RS) used for LI channel state information (CSI) measurement in the most recent slot. For example, the UE may determine, or have determined, a DL timing from a DL RS used for L1 CSI measurement in a most recently received slot. The UE may then utilize the determined DL timing for the UL transmission timing of the SRS towards the first cell. In particular, the UE may transmit an SRS transmission towards a base station operating the first cell in accordance with the determined DL timing.

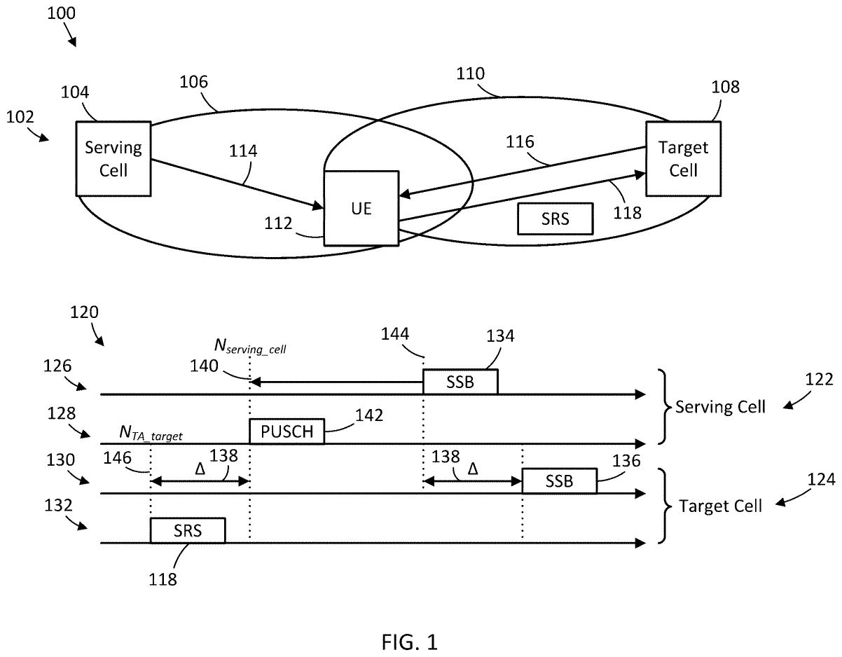

A second option may include ‘UE-based’ TA Offset Compensation. In a first step, referring to FIG. 1, an offset value, A, is first derived at UE based on the DL reception timing of the serving cell, T_{S}, and the DL reception timing of the target candidate cell, Tₜ, as follows: Δ=Tₜ−T_{S}.

For example, FIG. 1 illustrates an example UE-based timing compensation approach representation 100 in accordance with some embodiments. The UE-based timing compensation approach representation 100 may illustrate an approach for UE-based timing compensation for SRS transmission to enable two TAs.

The UE-based timing compensation approach representation 100 may include an example system arrangement 102. The system arrangement 102 may illustrate an arrangement of elements for which two TAs may be enabled. For example, a first TA may be enabled for a serving cell and a second TA may be enabled for a target cell.

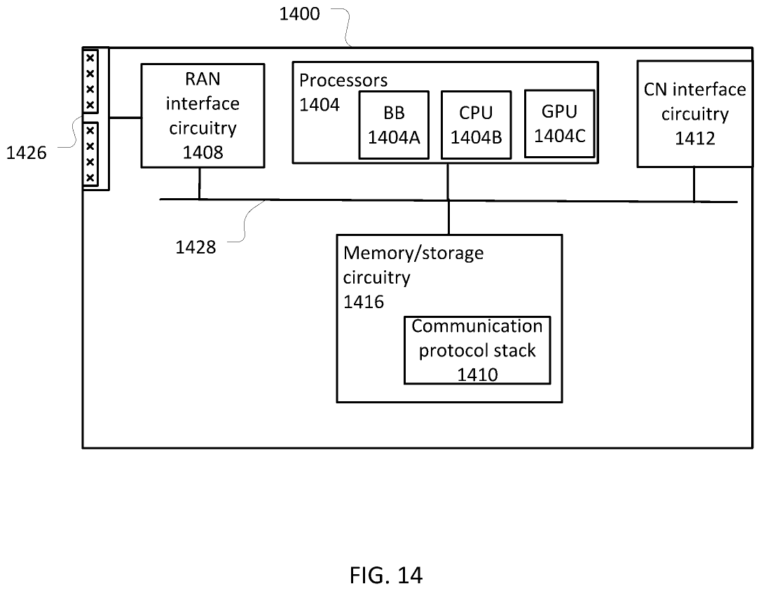

The system arrangement 102 may include a serving cell 104. The serving cell 104 may include a base station (such as the gNB 1400 (FIG. 14)) that provides services for the serving cell 104. The serving cell 104 may have a first service area 106. The base station of the serving cell 104 may provide the services to UEs located within the first service area 106.

The system arrangement 102 may include a target cell 108. The target cell 108 may include a base station (such as the gNB 1400) that provides services for the target cell 108. The target cell 108 may have a second service area 110. The base station of the target cell 108 may provide the services to UEs located within the second service area 110.

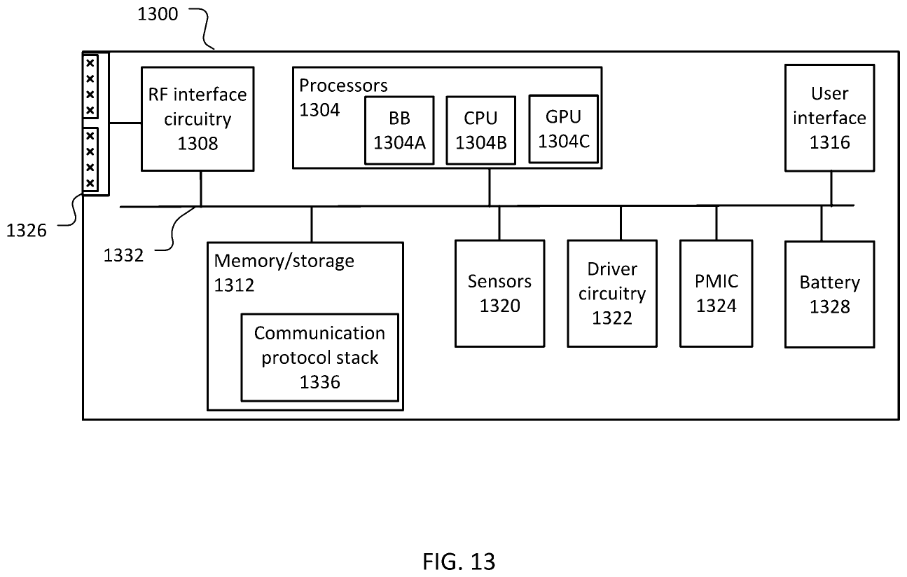

The system arrangement 102 may include a UE 112. The UE 112 may include one or more of the features of the UE 1300 (FIG. 13). In the illustrated embodiment, the UE 112 may be located within both the first service area 106 of the serving cell 104 and the second service area 110 of the target cell 108. Further, the UE 112 may have an established connection with the serving cell 104 in the illustrated embodiment, such that the serving cell 104 is providing services to the UE 112. For the described approach, the UE 112 may be triggered to transmit an aperiodic SRS transmission toward the target cell 108 and may derive a TA for the target cell 108.

The serving cell 104 may transmit a first DL transmission 114 to the UE 112. The UE 112 may determine a first DL reception timing of the serving cell 104 based on the first DL transmission 114, where the first DL reception timing may be referred to as T_{S}. The target cell 108 may transmit a second DL transmission 116 to the UE 112. The UE 112 may determine a second DL reception timing of the target cell 108 based on the second DL transmission 116.

The UE 112 may transmit an SRS transmission 118 to the target cell 108. The UE 112 may be triggered to transmit the SRS transmission 118 to the target cell 108 as described further throughout this disclosure. In the first option, the UE 112 may utilize a DL timing obtained from a DL RS used for L1 CSI measurement for a timing of the transmission of the SRS transmission 118. In particular, the UE 112 may transmit the SRS transmission 118 at a time in accordance with the determined DL timing.

In the second option, the UE 112 may utilize the determined first DL reception timing of the serving cell 104 and the determined second DL reception timing of the target cell 108 to determine a TA for the SRS transmission 118. The UE-based timing compensation approach representation 100 includes a timing chart 120 that illustrates the determination of the timing for the SRS transmission 118 in accordance with the second option.

The timing chart 120 indicates transmissions 122 for the serving cell 104 and transmissions 124 for the target cell 108. Further, the transmissions 122 for the serving cell 104 are separated into a first portion of transmissions 126 received by the UE 112 from the serving cell 104 and a second portion of transmissions 128 transmitted by the UE 112 to the serving cell 104. The transmissions 124 for the target cell 108 are separated into a third portion of transmissions 130 received by the UE 112 from the target cell 108 and a fourth portion of transmissions 132 transmitted by the UE 112 to the target cell 108.

In the illustrated embodiment of the timing chart 120, the UE 112 may receive a first SSB 134 from the serving cell 104. The UE 112 may determine the DL reception timing of the serving cell 104 based on the reception of the first SSB 134. The UE 112 may receive a second SSB 136 from the target cell 108. The UE 112 may determine the DL reception timing of the target cell 108 based on the reception of the second SSB 136. The UE 112 may determine an offset value A 138 between the determined DL reception timing of the serving cell 104 and the determined DL reception timing of the target cell 108. In some embodiments, the DL reception timing of the serving cell 104 may be obtained from a DL RS used for L1 CSI measurement of the serving cell 104 and the DL reception timing of the target cell 108 may be obtained from a DL RS used for LI CSI measurement of the target cell 108.

In some designs, a window may be configured by high-layers (e.g., RRC signaling or system information block (SIB) message), which starts from the last symbol of measured RS resource. During the window, the offset value A is considered to be valid for this candidate cell. The UE may stop storing/maintaining this offset value A after the window to minimize the memory cost. To save signaling overhead, a default value may be hard-encoded in specification. Alternatively, no default value is introduced and absence of this window configuration means to store the offset value A once it is obtained.

For example, a window for storage of the offset value 4 138. The window may define an amount of time for which the offset value 4 138 is stored. A length and/or initiation point of the window may be configured by high-layers, such as via RRC signaling or an SIB message. The UE 112 may be configured to initiate the window at a last symbol of a measured RS resource. For example, the UE 112 may initiate the window starting from the last symbol of the measured RS resource. The UE 112 may maintain the determined offset value 4 138 for the duration of the window, where the UE 112 may remove (e.g., stop storing/maintaining) the determined offset value 4 138 at the expiration of the window.

In a second step, upon receiving the SRS triggering towards the target non-serving cell, the UE adjusts the UL timing for SRS transmission based on the derived offset value A to the uplink timing of the serving cell as follows: NTA, target=Nserving_cell+4. For example, the UE 112 may determine a UL timing for the SRS transmission 118 based on the determined offset value 4 138. The UE 112 may determine a first UL timing 140 of the serving cell 104 (indicated as Nserving_cell in the illustrated embodiment), where the first UL timing 140 would result in a message (such as a physical uplink shared channel (PUSCH) message 142 in the illustrated embodiment) being received at time 144 in the illustrated embodiment. The time 144 may be indicated in the SRS triggering and/or be configured to the UE 112. The UE 112 may determine that the SRS transmission 118 is to be transmitted at a second UL timing 146 (indicated as NTA_target in the illustrated embodiment) that is the offset value 4 138 prior to the first UL timing 140. Accordingly, the UE 112 may determine that the SRS transmission 118 is to be transmitted at the second UL timing 146, which may be a TA for the target cell 108. Accordingly, the UE 112 may determine a first TA for the serving cell 104 and a second TA for the target cell 108.

In accordance with certain aspects of this disclosure, a set of new fields may be introduced for SRS resource set that is associated with a candidate non-serving cell. Two options may be considered for configuration of SRS resource set associated with non-serving cell, termed as ‘N-SRS Resource Set’ (N-SRS-RESET). In some instance, N-SRS-RESET may refer to non-serving cell-sounding reference signal resource set. One or more resources used for SRS transmissions may be configured within the N-SRS-RESET.

In a first option, an N-SRS-RESET of a candidate cell (where the candidate cell may comprise a target cell in some instance) may be configured as part of the serving cell configuration. For the first option, a new IE ‘physical cell ID’ or ‘additional PCI index’ may be provided to identify the target candidate cell. In some designs, a couple of information elements (IEs) needs to provide for the N-SRS-RESET. In particular, a Center Frequency of SSB and ssb-PositionsInBurst IE, a Point A of the target cell IE (which is used to derive SRS resource location in frequency domain), a subcarrier spacing (SCS) IE, and/or a sequence frame number (SFN) offset and The halfFrameIndex value IE may provide or the N-SRS-RESET. To reduce the signaling overhead, in case of absence of any of these IEs, a UE can assume the same as that of serving cell.

In a second option, an N-SRS-RESET of a candidate cell is configured as part of the associated ‘non-serving cell’ configuration. For the second option, various signal designs may be considered to manage the N-SRS-RESETs associated with different candidate cells. In a first alternative of the second option, a new medium access control (MAC)-control element (CE) may be introduced to activate/deactivate periodic and aperiodic N-SRS-RESETs. A UE may skip a periodic or a triggered aperiodic N-SRS-RESET if it is deactivated. In a second alternative of the second option, for aperiodic N-SRS-RESETs, a new MAC-CE may be introduced to faster map the N-SRS-RESETs with an SRS request codepoint. The MAC-CE of the second option may be used to map N-SRS-RESETs with a corresponding codepoint of an SRS request field in a DCI format.

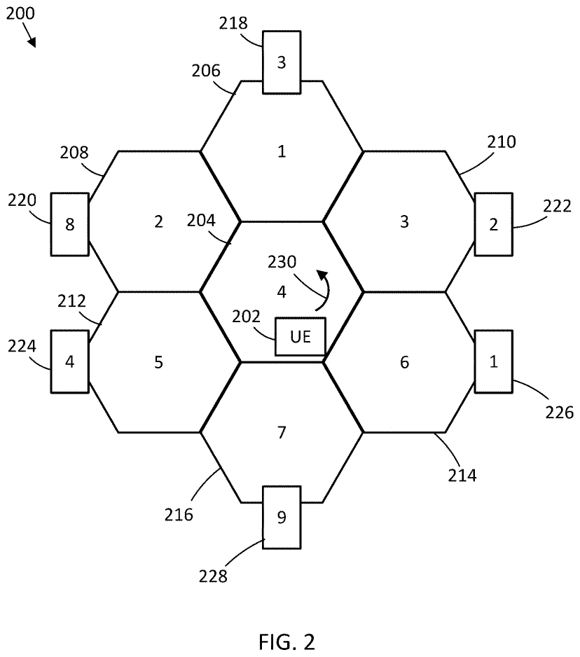

FIG. 2 illustrates an example N-SRS-RESET activation/deactivation for candidate cells arrangement 200 in accordance with some embodiments. For example, the N-SRS-RESET activation/deactivation for candidate cells arrangement 200 may illustrate a faster N-SRS-RESET activation/deactivation for candidate cells in accordance with the second alternative of the second option. Referring to FIG. 2, during UE moving, network is able to update the activated N-SRS-RESETs from <1,2,9> for candidate cells <6,3,7> to <3,8,2> associated with candidate cell <1,2,3> e.g., based on the beam reporting for candidate cells.

For example, the arrangement 200 may include a UE 202. The UE 202 may include one or more of the features of the UE 1300 (FIG. 13). The UE 202 may be located within a fourth cell 204. The fourth cell 204 may be performing service to the UE 202.

The arrangement 200 may include one or more non-serving cells around the serving cell. In the illustrated embodiment, the arrangement 200 includes a first cell 206, a second cell 208, a third cell 210, a fifth cell 212, a sixth cell 214, and a seventh cell 216 that operate as non-serving cells in the illustrated embodiment.

The UE 202 may be configured with identifiers (IDs) of N-SRS-RESETS mapped to each of the activated non-serving cells. The UE 202 may be configured with the identifier mappings of the N-SRS-RESETs to the activated non-serving cells via a MAC-CE. In the illustrated embodiment, the first cell 206, the second cell 208, the third cell 210, the fifth cell 212, the sixth cell 214, and the seventh cell 216 may be activated non-serving cells. The IDs of the N-SRS-RESETs mapped to the cells are indicated by the numbers in the rectangle illustrated at the edges of the cells in the illustrated embodiment. In particular, the first cell 206 is assigned a third N-SRS-RESET ID 218, the second cell 208 is assigned an eighth N-SRS-RESET ID 220, the third cell 210 is assigned a second N-SRS-RESET ID 222, the fifth cell is assigned a fourth N-SRS-RESET ID 224, the sixth cell 214 is assigned a first N-SRS-RESET ID 226, and the seventh cell 216 is assigned a ninth N-SRS-RESET ID 228 in the illustrated embodiment.

The UE 202 may be moving in the illustrated embodiment, as illustrated by the arrow 230. As the UE 202 is moved in the illustrated embodiment, the UE 202 may begin near the third cell 210, the sixth cell 214, and the seventh cell 216. The network may have the activated N-SRS-RESETs based on the beginning position of the UE 202 as the second N-SRS-RESET ID 222 corresponding to the third cell 210, the first N-SRS-RESET ID 226 corresponding to the sixth cell 214, and the ninth N-SRS-RESET ID 228 corresponding to the seventh cell 216. The UE 202 may move to a position where it is close to first cell 206, the second cell 208, and the third cell 210. The network may update the activated N-SRS-RESETs based on the beam reporting of the candidate cells. For the illustrated embodiment, the network may update the activated N-SRS-RESETs to the third N-SRS-RESET ID 218 corresponding to the first cell 206, the eighth N-SRS-RESET ID 220 corresponding to the second cell 208, and the second N-SRS-RESET ID 222 corresponding to the third cell 210 based on the beam reporting when the UE is moved to the position close to the first cell 206, the second cell 208, and the third cell 210.

Power Control fields for N-SRS-RESET associated with a given target cell may be as described in the following. Open-Loop Power Control parameters may include separate PO and pathloss compensation factor (a) value. In some designs, if no IE is provided, the serving cell's configuration may be assumed. For example, the PO value and the a value may preconfigured, or may be determined based on preconfigured values and factors related to the target cell, in the absence of IEs being provided related to the open-loop power control. In some embodiments, a configuration of an N-SRS-RESET may include a PO parameter and a pathloss compensation factor (a) for a target cell.

For pathloss reference signal (RS), an SSB Index of target cell or a channel state information (CSI)-reference signal (RS) may be provided by RRC signaling as part of a N-SRS-RESET configuration. For SSB-based pathloss (PL)-RS, the SSB transmission power may be provided by network by ss-physical broadcast channel (PBCH)-BlockPower IE for each candidate cell. For example, a base station (such as a base station of a serving cell of a UE) may transmit an ss-PBCH-BlockPower IE to a UE that provides the SSB transmission powers for each of the candidate cells (such as the candidate cells described in relation to the arrangement 200 (FIG. 2)). To minimize overhead, a default value may be hard-encoded in specification (e.g., same as the SSB transmission power of the current serving cell). For example, the UE may be configured with a default value of SSB transmission power that can be utilized in the absence of receiving an ss-PBCH-BlockPower IE.

For Closed-Loop (CL) power control parameters, as there is no physical uplink shared channel (PUSCH) transmission for this non-serving cell yet, a UE may expect to be configured with ‘separate CL.’ Alternatively, ‘separate CL’ may be assumed for N-SRS-RESET by default without need of explicit configuration. In some designs, the existing downlink control information (DCI) format 2_3 may be enhanced to provide transmit power control (TPC)-commands for candidate cells for LTM operation. In a first embodiment, an ‘additional physical cell identifier (PCI) index’ field may be introduced and provided for each TPC command in the DCI format 2_3.

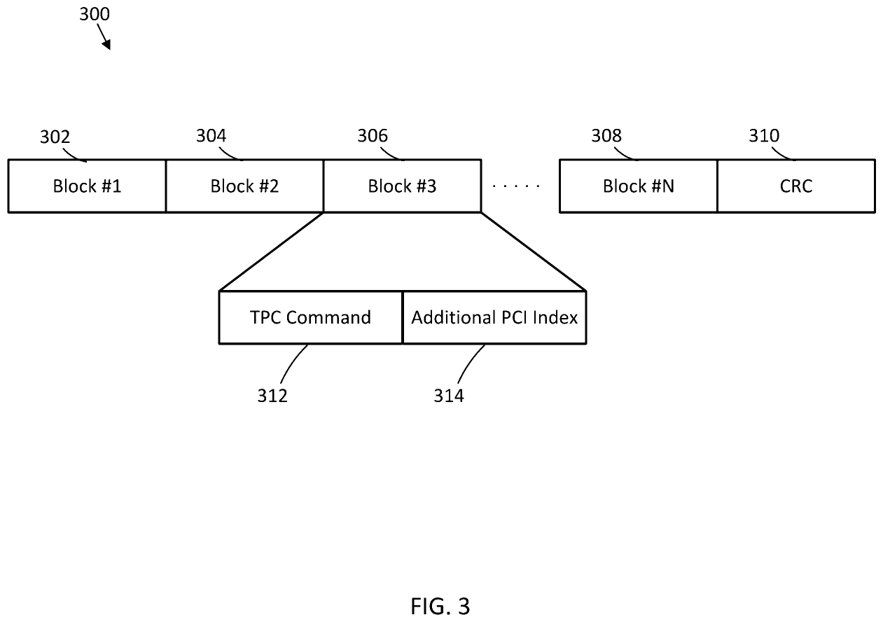

FIG. 3 illustrates an example enhanced DCI format 2_3 300 to provide TPC for candidate cells in accordance with some embodiments. For example, the DCI format 2_3 300 illustrates an example DCI format 2_3 that provides TPC command for candidate cells for LTM operation as described throughout this disclosure.

The enhanced DCI format 2_3 300 may include a plurality of blocks. For example, the DCI 2_3 300 includes a first block 302, a second block 304, a third block 306, and an N-block 308 in the illustrated embodiment. The enhanced DCI format 2_3 300 may further include a cyclic redundancy check (CRC) block 310. The CRC block 310 may be located at the end of the enhanced DCI format 2_3 300.

One or more of the blocks may include a TPC command. For example, the third block 306 may include a TPC command 312 in the illustrated embodiment. Any of the blocks that include a TPC command may further include an additional PCI index. For example, the third block 306 includes an additional PCI index 314 in the illustrated embodiment based on the third block 306 including the TPC command 312. The additional PCI index 314 may indicate a candidate cell which is to receive and/or process the TPC command 312.

According to certain aspects of this disclosure, the following alternatives may be considered to determine the spatial relation for N-SRS-Resource Set Transmission.

In a first alternative, it may be explicitly configured using ‘SRS-SpatialRelationInfo’ for each N-SRS Resource in a N-SRS-RESET to associate with a SSB Index of the candidate cell. This alternative may allow an SSB-specific N-SRS-RESET configuration to minimize overhead. For example, the network may configure beams transmitted by a base station with separate N-SRS-RESETs.

In a second alternative, the SSB with the largest measured L1-RSRP in the most recent CSI report associated with candidate cell that has the N-SRS-RESET configuration may be utilized for the spatial relation. This alternative is used for the UE-selected SRS transmission.

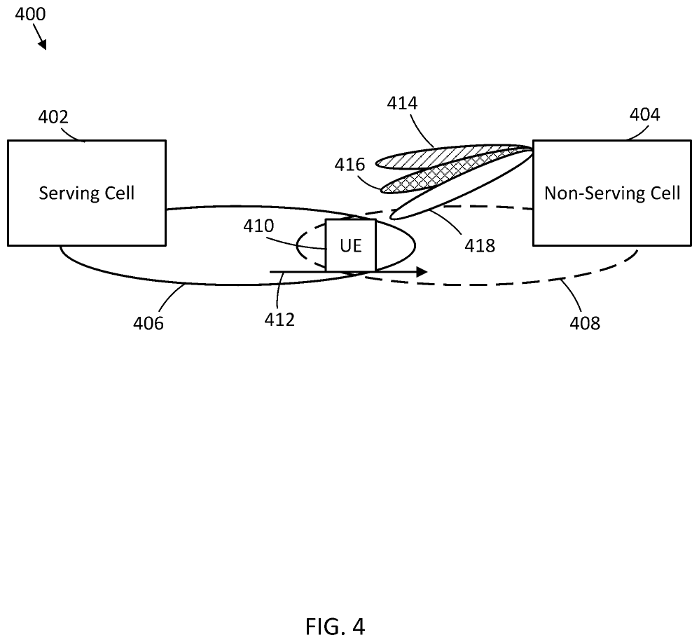

FIG. 4 illustrates an example spatial relation arrangement 400 in accordance with some embodiments. The spatial relation arrangement 400 may provide spatial relation information for SRS resource set configured for non-serving cell in accordance with some embodiments. FIG. 4 provides one example to depict the first alternative and the second alternative with the following assumptions. Three beams, i.e., Beam #0/#1/#2, are operated by the candidate non-serving cell.

For example, the spatial relation arrangement 400 may include a serving cell 402 and a non-serving cell 404. The serving cell 402 may be operated by a first base station and the non-serving cell 404 may be operated by a second base station. The first base station and the second base station may include one or more of the features of the gNB 1400 (FIG. 14). The serving cell 402 may have a first service area 406 and the non-serving cell 404 may have a second service area 408.

The spatial relation arrangement 400 may include a UE 410. The UE 410 may include one or more of the features of the UE 1300 (FIG. 13). The UE 410 may be located within the first service are 406 of the serving cell 402 and the second service area 408 of the non-serving cell 404 in the illustrated embodiment. The serving cell 402 may be providing service to the UE 410. The UE 410 may be moving away from the serving cell 402 and toward the non-serving cell 404 in the illustrated embodiment, as indicated by arrow 412.

The non-serving cell 404 may transmit one or more beams. For example, the non-serving cell 404 is illustrated as transmitting three beams in the illustrated embodiment. In particular, the non-serving cell 404 is shown transmitting a first beam 414, a second beam 416, and a third beam 418 toward the UE 410 in the illustrated embodiment.

With the first alternative, network may configure separate N-SRS-Resource Set #1/#2 for the beams with SSB#1 and SSB#2, respectively. However, no N-SRS-Resource Set is configured for the beams with SSB#0. For example, the non-serving cell 404 may configure the first beam 414 with no N-SRS-RESET and SSB#0, the second beam 416 with a first N-SRS-RESET and SSB#1, and the third beam 418 with a second N-SRS-RESET and SSB#2. Network may utilize N-SRS-Resource Set #1 transmission to obtain the UL TA associated with second beam 416 that transmits SSB#1. For example, a UL TA for the non-serving cell 404 may be determined based on the second beam 416 in the illustrated embodiment.

With second alternative, assuming a same N-SRS-Resource Set configuration for non-serving cell and the L1-reference signal received power (RSRP) associated with SSB#2 is the largest, UE may select the N-SRS-Resource Set #2 when aperiodic SRS is triggered and resource is selected by the UE. For example, the UE 410 may determine L1-RSRPs for the SSBs for each of the first beam 414, the second beam 416, and the third beam 418. The UE 410 may determine that SSB#2 transmitted via the third beam 418 presents the largest L1-RSRP of the SSBs. Based on the UE 410 determining that the SSB#2 presents the largest L1-RSRP, the UE may select the N-SRS-RESET#2 associated for transmission of an SRS to the non-serving cell when the SRS is triggered.

According to certain aspects of this disclosure, various signaling approaches may be considered to trigger an SRS resource set transmission towards the candidate non-serving cell. For a first alternative, a trigger for an SRS resource set transmission may include adding the ‘physical cell ID’ or ‘additional PCI index’ of a candidate cell for an SRS resource set associated with the cell. For example, a base station may transmit a transmission to a UE to trigger an SRS resource set transmission that include a physical cell ID or an additional PCI index of a candidate cell.

For a second alternative, the ‘additional PCI index’ may be added into a DCI format 0_1 in UE-specific search space (USS) to indicate the candidate cell that the SRS request field in the same DCI format is applied for. For example, a base station may transmit a transmission in a DCI format 0_1 in a USS to indicate a candidate cell that an SRS request field in the same DCI format has been applied.

For a third alternative, a new MAC-CE may be introduced to faster associate the codepoint of ‘aperiodicSRS-ResourceTrigger’ field and N-SRS Resource Sets for candidate cells. The new MAC-CE is identified by a MAC-subheader with dedicated logical channel identifier (LCID). The new MAC-CE may consist of a couple of fields. A first field may be an AperiodicSRS-ResourceTrigger. The AperiodicSRS-ResourceTrigger may include up to 2-bits, indicating the associated codepoint of ‘SRS request’ field in DCI format. A second field may include an SRS Resource Set ID and the associated non-serving cell ID, including ‘physical cell ID’or ‘additional PCI index’of the candidate cell.

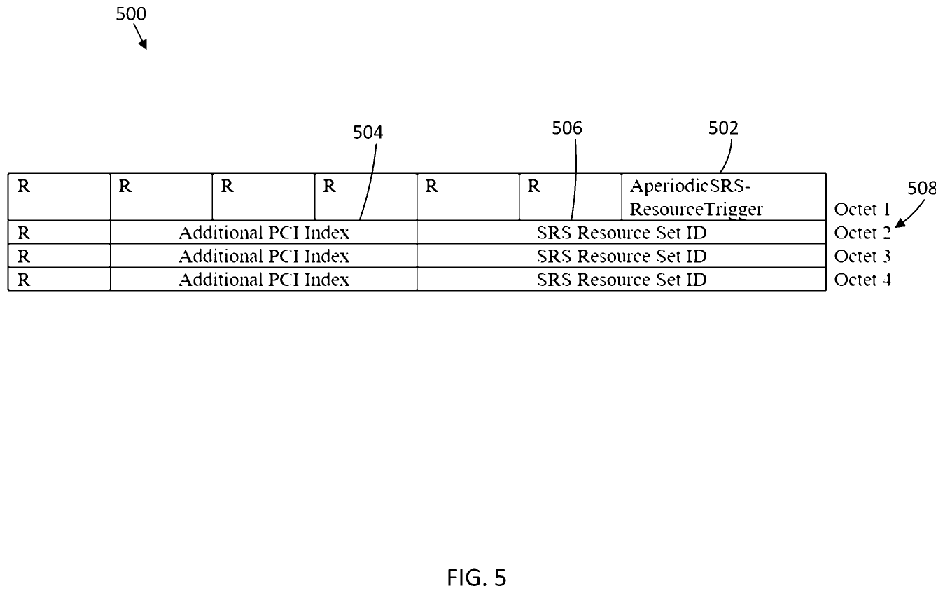

FIG. 5 illustrates an example MAC-CE format 500 in accordance with some embodiments. The MAC-CE format 500 may illustrate a MAC-CE based aperiodic SRS triggering update for N-SRS-RESET towards a candidate cell in accordance with some embodiments. The MAC-CE format 500 may include an exemplified MAC-CE format based on third alternative, assuming a single SRS resource ID of a candidate cell to be associated with a triggering state codepoint.

The MAC-CE format 500 may include one or more octets that is utilized for associating a codepoint of aperiodicSRS-ResourceTrigger field and N-SRS Resource Sets for candidate cells. The MAC-CE format 500 may include an AperiodicSRS-ResourceTrigger field 502 to indicate that the MAC-CE is to trigger an aperiodic SRS to a candidate cell. The MAC-CE format 500 may further include one or more additional PCI index and SRS resource set ID pairs for associating the aperiodicSRS-ResourceTrigger field and N-SRS Resource sets. For example, the MAC-CE format 500 may include a first additional PCI index 504 and a first SRS resource set ID 506 paired within a second octet 508 of the MAC-CE format 500. The paired first additional PCI index 504 and the first SRS resource set ID 506 may indicate that the first SRS resource set ID 506 is to be associated with a triggering state codepoint associated with the first additional PCI index 504. In other embodiments, physical cell IDs may replace the additional PCI indexes in the pairs.

### UE-Initiated RACH for LTM Procedure

According to certain aspects of this disclosure, a UE may initiate RACH procedure to trigger LTM procedure and obtain TA for the target cell in instances when certain conditions are met. In a first alternative, a condition for initiating a RACH procedure to trigger an LTM procedure may include the candidate cell becoming offset better than the current serving cell where offset value is provided by RRC signaling. For example, a UE (such as the UE 1300 (FIG. 13)) may determine a first offset value associated with a candidate cell (such as the candidate cells described in relation to the arrangement 200 (FIG. 2)). Further, the UE may determine a second offset value associated with a serving cell (such as the serving cell 104 (FIG. 1) and/or the serving cell 402 (FIG. 4)). The UE may compare the first offset value and the second offset value, and may determine that the first offset value associated with the candidate cell is better (e.g., is a smaller offset value) than the second offset value associated with the serving cell. The UE may determine that the RACH procedure is to be triggered based on the first offset value associated with candidate cell being better than the second offset value associated with the serving cell.

In some embodiments, the UE may determine that one or more conditions are met to initiate a RACH procedure to trigger an LTM procedure and obtain a TA for a target cell. In some embodiments, meeting the one or more conditions may include determining that a measurement result of the target cell is better than a measurement result of a serving cell. Further, the one or more conditions may include a difference of the measurement result of the target cell and the measurement result of the serving cell being equal to or larger than an offset value. In some embodiments, the offset value may be determined based on RRC signaling.

In a second alternative, a condition for initiating a RACH procedure to trigger an LTM procedure may include using two thresholds for determining when to initiate the RACH procedure. For example, two thresholds may be configured by RRC signaling (e.g., a first threshold T₁ and a second threshold T₂, respectively). The RACH Procedure is trigged if the measured result of serving cell becomes worse than the first threshold T₁ and at least one measured result associated with non-serving cell becomes better than the second threshold T₂. For example, a base station may configure a UE with a first threshold T₁ and a second threshold T₂. The base station may configure the UE with the thresholds via RRC signaling. The UE may determine a measured result of the serving cell and at least one measured result associated with a non-serving cell. In some embodiments, the measured results may comprise a first offset value associated with the serving cell and a second offset value associated with the non-serving cell. The UE may determine whether the measured result of the serving cell is worse (for example, having a larger first offset value) than the first threshold T₁ and the at least one measured result associated with the non-serving cell is better (for example, having a smaller second offset value) than the second threshold 72. The UE may determine that the RACH procedure is to be triggered based on the measured result of the serving cell being worse than the first threshold T₁ and at least one measured result associated with the non-serving cell being better than the second threshold T₂.

In some embodiments, enabling a UE-initiated PRACH for LTM may be controlled by network by introducing a configurable parameter as part of LTM configuration for a given candidate cell. For example, a base station may transmit a configurable parameter to a UE as part of an LTM configuration for a candidate cell. The configurable parameter may indicate whether a UE-initiated PRACH for LTM is to be enabled for the candidate cell.

In addition, to differentiate the PRACH transmission of LTM with that of initial access procedure, a dedicated PRACH resource may be configured by RRC signaling for each candidate SSB of a candidate cell. The RRC signaling may include the following IEs: PRACH resource configuration of the candidate cell, SSB-perRACH-Occasion, and/or one or more pairs of <SSB, dedicated RACH resource index>. For example, a base station may configure a UE with a dedicated PRACH resource for each candidate SSB of a candidate cell. The base station may configure the UE via RRC signaling. The RRC signaling may include a PRACH resource configuration of the candidate cell IE, an SSB-perRACH-Occasion IE, and/or one or more pairs of SSB and dedicated RACH resource index IEs.

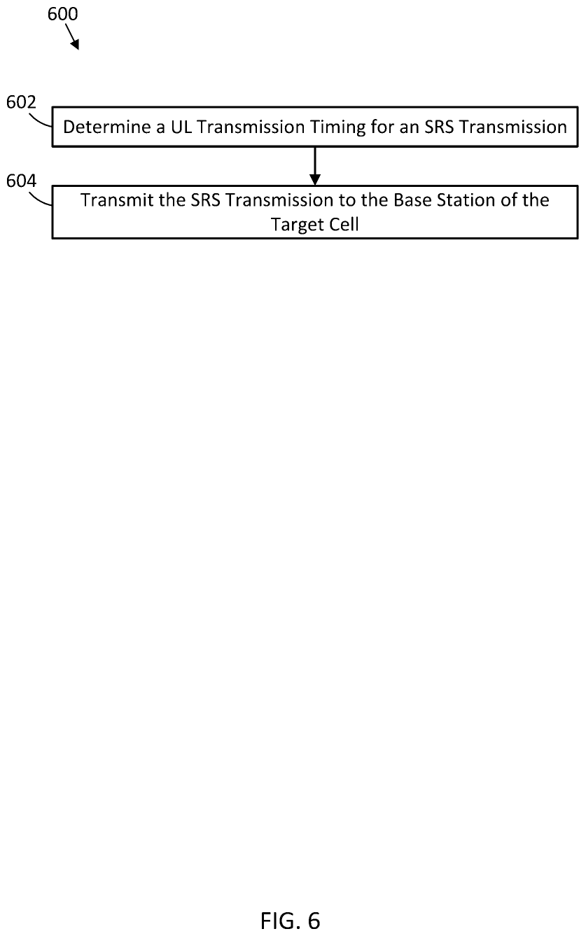

FIG. 6 illustrates an example procedure 600 of operating a UE in accordance with some embodiments. The UE may include one or more of the features of the UE 112 (FIG. 1), the UE 202 (FIG. 2), the UE 410 (FIG. 4), and/or the UE 1300 (FIG. 13). The procedure 600 may provide for transmission of an SRS transmission to a target cell.

The procedure 600 may include determining a UL transmission timing for an SRS transmission in 602. For example, the UE may determine a UL transmission timing for an SRS transmission to a base station of a target cell. The UE may be served by a based station of a serving cell.

In some embodiments, determining the UL transmission timing may include determining a DL timing obtained from a DL RS used for LI CSI measurement. Further, determining the UL transmission timing for the SRS transmission may include determining an offset value based on a DL reception timing obtained from a DL RS for L1 CSI measurement of the serving cell and a DL reception timing obtained from a DL RS used for L1 CSI measurement of the target cell in some embodiments.

In some embodiments, the UE may initiate a window starting from a last symbol of a measured RS resource. The UE maintain the determined offset value for a duration of the window. Further, the UE may remove the offset value after termination of the window.

In some embodiments, the UE may configure a N-SRS-RESET associated with the target cell. The N-SRS-RESET may be configured as part of a serving cell configuration in some embodiments. The N-SRS-RESET may include a physical cell ID or an additional PCI index that identifies the target cell. In some embodiments, the N-SRS-RESET may indicate a center frequency of an SSB and an ssb-PositionsInBurst field, a point A of the target cell to be utilized to derive SRS resource location in a frequency domain, an SCS, or an SFN offset and a halfFrameIndex value.

In some embodiments, the N-SRS-RESET may be configured as part of a non-serving cell configuration. The N-SRS-RESET may be activated/deactivated by an MAC-CE. Further, an MAC-CE may be used to map N-SRS-RESETs with a corresponding codepoint of an SRS request field in a DCI format in some embodiments. In some embodiments, the configuration of the N-SRS-RESET may include a PO and a pathloss compensation factor (a) for the target cell.

In some embodiments, the UE may further receive, via RRC signaling, an SSB index of the target cell or a CSI-RS for the N-SRS-RESET. Further, the UE may receive, via an ss-PBCH-BlockPower IE, SSB transmission power for the target cell. In some embodiments, the UE may receive a TPC-command for the target cell for LTM within a DCI format 2_3 transmission.

In some embodiments, the UE may further determine a spatial relation for N-SRS-RESET transmission based on SRS-SpatialRelationInfo for each N-SRS resource in the N-SRS-RESET. Further, the UE may determine an SSB with a largest measured L1-RSRP for a most recent CSI report associated with the target cell.

The procedure 600 may include transmitting the SRS transmission to the base station of the target cell in 604. In particular, the UE may transmit the SRS transmission to the base station of the target cell in accordance with the determined UL transmission timing for the SRS. In some embodiments, one or more resources used for SRS transmissions may be configured within the N-SRS-RESET associated with the target cell. In some embodiments, transmitting the SRS transmission may include transmitting the SRS transmission based on the determined offset value and a UL transmission timing of the serving cell.

In some embodiments, the SRS transmission may be triggered based on a physical cell ID or an additional PCI index of the target cell for an SRS resource set for the target cell. Further, the SRS transmission may be triggered based on an additional PCI index included in a DCI format 0_1 in a USS in some examples. In some embodiments, the SRS transmission may be triggered based on a MAC-CE to associate a codepoint of an aperiodicSRS-ResourceTrigger field and N-SRS-RESETs for the target cell.

Although FIG. 6 may arguably imply an order of the operation of the procedure 600, it should be understood that the operations may be performed in a different order and/or one or more of the operations may be concurrently performed in other embodiments. Further, it should be understood that one or more of the operations of the procedure 600 may be omitted and/or one or more additional operations may be added to the procedure 600 in other embodiments.

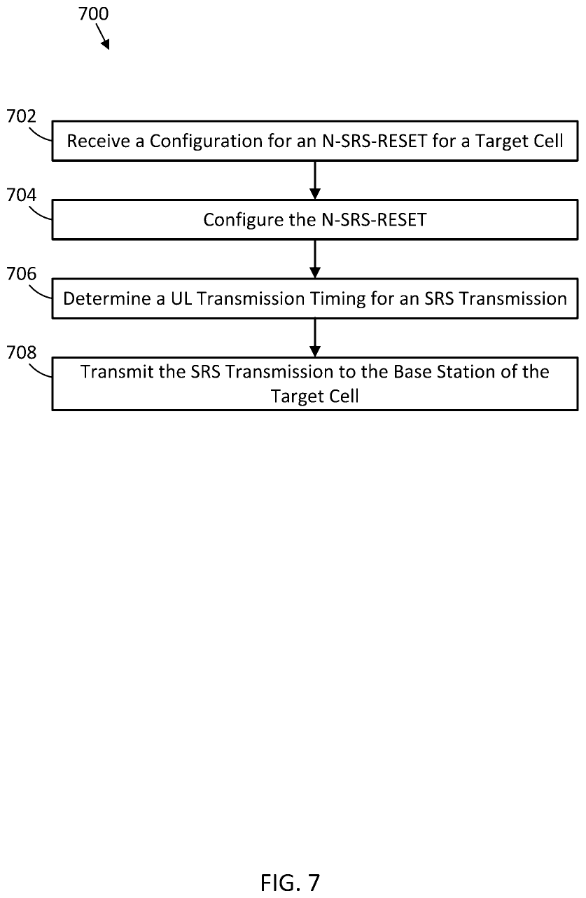

FIG. 7 illustrates an example procedure 700 of operating a UE in accordance with some embodiments. The UE may include one or more of the features of the UE 112 (FIG. 1), the UE 202 (FIG. 2), the UE 410 (FIG. 4), and/or the UE 1300 (FIG. 13). The procedure 700 may provide for transmission of an SRS transmission to a target cell.

The procedure 700 may include receiving a configuration for an N-SRS-RESET for a target cell in 702. In particular, the UE may receive a configuration for the N-RESET for the target cell. The UE may be served by a serving cell.

The procedure 700 may include configuring the N-SRS-RESET in 704. In particular, the UE may configure the N-SRS-RESET in accordance with the received configuration.

In some embodiments, the N-SRS-RESET may be configured as part of a serving cell configuration. Further, the N-SRS-RESET may include a physical cell ID or an additional PCI index that identifies the target cell in some embodiments. In some embodiments, the N-SRS-RESET may indicate a center frequency of an SSB and an ssb-PositionsInBurst field, a point A of the target cell to be utilized to derive SRS resource location in a frequency domain, an SCS, and/or an SFN offset and a halfFrameIndex value.

In some embodiments, the N-SRS-RESET may be configured as part of a non-serving cell configuration. Further, the N-SRS-RESET may be activated/deactivated by a MAC-CE in some embodiments. In some embodiments, a MAC-CE may be used to map N-SRS-RESETs with a corresponding codepoint of an SRS request field in a DCI format.

In some embodiments, the configuration of the N-SRS-RESET may include a PO parameter and a pathloss compensation factor (a) for the target cell.

In some embodiments, the UE may further receive, via RRC signaling, an SSB index of the target cell or a CSI-RS for the N-SRS-RESET. Further, the UE may receive, via an ss-PBCH-BlockPower IE, SSB transmission power for the target cell in some embodiments. In some embodiments, the UE may further receive a TPC-command for the target cell for LTM within a DCI format 2_3 transmission.

The procedure 700 may include determining a UL transmission timing for an SRS transmission in 706. In particular, the UE may determine a UL transmission timing for an SRS transmission to a base station of the target cell.

In some embodiments, determining the UL transmission timing may include determining a DL timing obtained from a DL RS used for L1 CSI measurement. Further, determining the UL transmission timing may include determining an offset value based on a DL reception timing obtained from a DL RS used for LI CSI measurement of the serving cell and a DL reception timing obtained from a DL RS used for L1 CSI measurement of the target cell.

In some embodiments, the UE may further initiate a window starting from a last symbol of a measured RS resource. The UE may further maintain the determined offset value for a duration of the window. Further, the UE may remove the offset value after termination of the window.

In some embodiments, the UE may further determine a spatial relation for N-SRS-RESET transmission based on SRS-SpatialRelationInfo for each N-SRS resource in the N-SRS-RESET. Further, the UE may determine an SSB with a largest measured L1-RSRP for a most recent CSI report associated with the target cell in some embodiments.

The procedure 700 may include transmitting the SRS transmission to the base station of the target cell in 708. In particular, the UE may transmit the SRS transmission to the base station of the target cell in accordance with the determined UL transmission timing for the SRS transmission.

In some embodiments, transmitting the SRS transmission may include transmitting the SRS transmission in accordance with the determined UL transmission timing. Further, transmitting the SRS transmission may include transmitting the SRS transmission based on the determined offset value and a UL transmission timing of the serving cell.

In some embodiments, the SRS transmission may be triggered based on a physical cell ID or an additional PCI index of the target cell for an SRS resource set for the target cell. Further, the SRS transmission may be triggered based on an additional PCI index included in a DCI format 0_1 in a USS in some embodiments. In some embodiments, the SRS transmission is triggered based on an MAC-CE to associate a codepoint of an aperiodicSRS-ResourceTrigger field and N-SRS-RESETs for the target cell.

Although FIG. 7 may arguably imply an order of the operation of the procedure 700, it should be understood that the operations may be performed in a different order and/or one or more of the operations may be concurrently performed in other embodiments. Further, it should be understood that one or more of the operations of the procedure 700 may be omitted and/or one or more additional operations may be added to the procedure 700 in other embodiments.

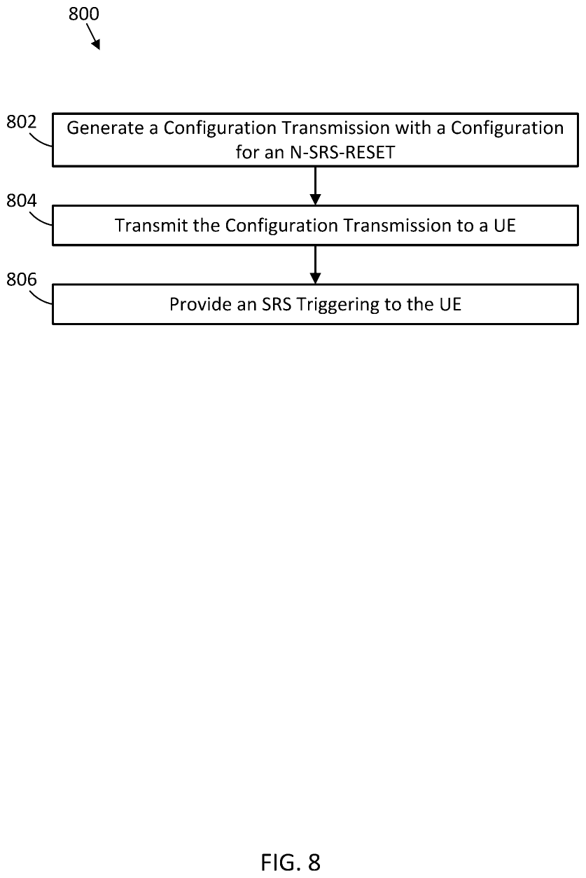

FIG. 8 illustrates an example procedure 800 of operating a base station in accordance with some embodiments. The base station may include one or more of the features of the gNB 1400 (FIG. 14). The procedure 800 may provide for operations related to an SRS transmission for LTM to be performed.

The procedure 800 may include generating a configuration transmission with a configuration for an N-SRS-RESET in 802. In particular, the base station may generate a configuration transmission with a configuration for an N-SRS-RESET. The N-SRS-RESET may define resources for transmission of SRS transmissions. In some embodiments, the configuration of the N-SRS-RESET may include a PO parameter and a pathloss compensation factor (a) for a target cell.

The procedure 800 may include transmitting the configuration transmission to the UE in 804. In particular, the base station may transmit the configuration transmission to the UE. The UE be to determine a resource for transmission of an SRS to a target cell.

In some embodiments, the configuration transmission may be transmitted as part of a service cell configuration. The N-SRS-RESET may include a physical cell ID IE or an additional PCI index IE that identifies the target cell for the transmission of the SRS by the UE in some embodiments. In some embodiments, the N-SRS-RESET may comprise a center frequency of SSB and ssb-PositionsInBurst IE, a point A of the target cell IE (the point A of the target cell IE used to derive an SRS resource location in a frequency domain), and/or an SFN offset and a halfFrameIndex value IE.

In some embodiments, the configuration transmission may be transmitted as part of a non-serving cell configuration. The N-SRS-RESET may be activated/deactivated by an MAC-CE in some embodiments. In some embodiments, an MAC-CE may be used to map N-SRS-RESETs with a codepoint of an SRS request field in a DCI format.

In some embodiments, the base station may further transmit a DL RS to the UE. The DL RS may be utilized for determining DL timing. The SRS may be transmitted by the UE based on the determined DL timing.

In some embodiments, the base station may be a first base station, wherein the first base station is associated with a first cell. The first base station may transmit a first SSB to the UE. The UE may be to determine an offset value for timing for transmission of the SRS based on a reception of the first SSB received from the first base station and a second SSB received from a second base station associated with a second cell. In some of these embodiments, the base station may further configure, via RRC signaling or an SIB, a window for the UE, wherein the UE may be to maintain the offset value for a duration of the window and remove the offset value based on the termination window.

In some embodiments, the base station may further transmit, via an ss-PBCH-BlockPower IE, SSB transmission power for the target cell. Further, the base station may transmit a TPC-command for the target cell for LTM within a DCI format 2_3 transmission in some embodiments. In some embodiments, the base station may transmit SRS-SpatialRelationInfo for each N-SRS resource in the N-SRS-RESET to indicate a spatial relation for the N-SRS-RESET.

The procedure 800 may include providing an SRS triggering to the UE in 806. In particular, the base station may provide an SRS triggering to the UE to trigger transmission of the SRS by the UE.

In some embodiments, the SRS triggering may include a physical cell ID or an additional PCI index of the target cell for the N-SRS-RESET. Further, the SRS triggering may include an additional PCI index in a DCI format 0_1 in a USS in some embodiments. In some embodiments, the SRS triggering may include a MAC-CE to associate a codepoint of an aperiodicSRS-ResourceTrigger field and N-SRS-RESETs for the target cell.

Although FIG. 8 may arguably imply an order of the operation of the procedure 800, it should be understood that the operations may be performed in a different order and/or one or more of the operations may be concurrently performed in other embodiments. Further, it should be understood that one or more of the operations of the procedure 800 may be omitted and/or one or more additional operations may be added to the procedure 800 in other embodiments.

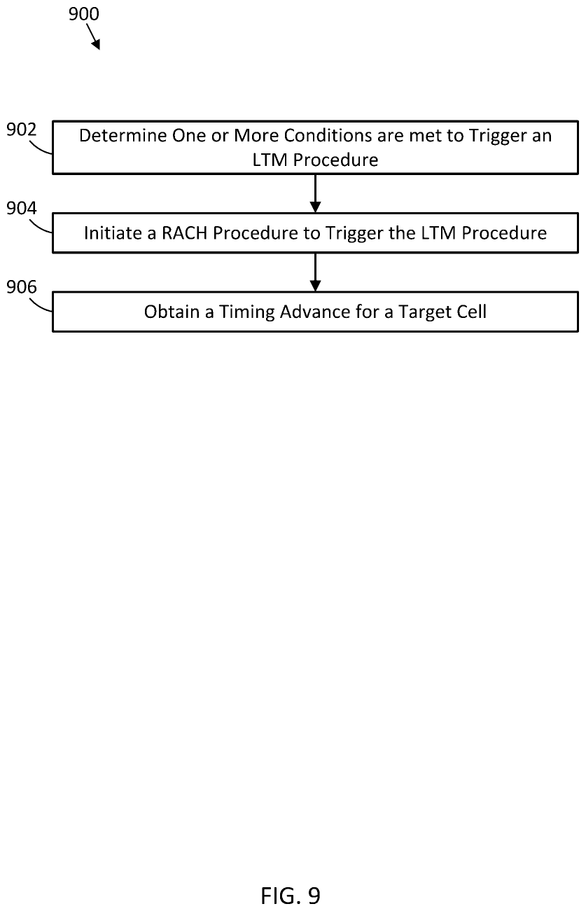

FIG. 9 illustrates an example procedure 900 of operating a UE in accordance with some embodiments. The UE may include one or more of the features of the UE 112 (FIG. 1), the UE 202 (FIG. 2), the UE 410 (FIG. 4), and/or the UE 1300 (FIG. 13). The procedure 900 may provide for UE-initiated RACH for an LTM procedure.

The procedure 900 may include determining one or more conditions are met to trigger an LTM procedure in 902. In particular, the UE may determine one or more conditions are met to trigger an LTM procedure.

In some embodiments, determining the one or more conditions are met may include determining that a measurement result of the target cell is better than a measurement result of a serving cell and the different of the measurement result of the target cell and the measurement result of the serving cell is equal to or larger than an offset value. Further, the offset value may be determined based on RRC signaling in some embodiments.

In some embodiments, the UE may further receive an indication of a first threshold value and a second threshold value. In some of these embodiments, determining the one or more conditions are met may include determining that a measured result of a serving cell is worse than the first threshold value and determining that at least one measured result of the target cell is better that the second threshold value. In some embodiments, the indication of the first threshold value and the second threshold value may be received via RRC signaling.

In some embodiments, the UE may further receive an LTM configuration for the target cell and determine that a UE-initiated PRACH for LTM is enabled based on a configurable parameter of the LTM configuration. The LTM configuration may include a dedicated PRACH resource for each SSB of the target cell in some embodiments. In some embodiments, the dedicated PRACH resource for each SSB of the target cell may be configured via RRC signaling. Further, the RRC signaling may include a PRACH resource configuration IE of the target cell, an SSB-perRACH-Occasion IE, and/or pairs of SSB and dedicated RACH resource indexes IE in some embodiments.

The procedure 900 may include initiating a RACH procedure to trigger the LTM procedure in 904. In particular, the UE may initiate a RACH procedure to trigger the LTM procedure based on the one or more conditions being met.

The procedure 900 may include obtaining a TA for a targeted cell in 906. In particular, the UE may obtain a TA for a target cell based on the one or more conditions being met.

Although FIG. 9 may arguably imply an order of the operation of the procedure 900, it should be understood that the operations may be performed in a different order and/or one or more of the operations may be concurrently performed in other embodiments. Further, it should be understood that one or more of the operations of the procedure 900 may be omitted and/or one or more additional operations may be added to the procedure 900 in other embodiments.

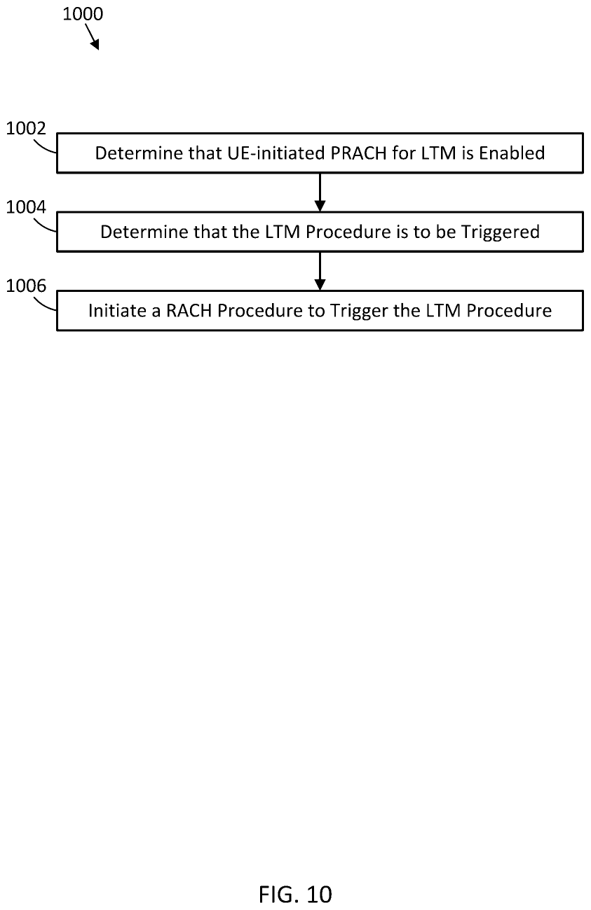

FIG. 10 illustrates an example procedure 1000 of operating a UE in accordance with some embodiments. The UE may include one or more of the features of the UE 112 (FIG. 1), the UE 202 (FIG. 2), the UE 410 (FIG. 4), and/or the UE 1300 (FIG. 13). The procedure 1000 may provide for UE-initiated RACH for an LTM procedure.

The procedure 1000 may include determining that UE-initiated PRACH for LTM is enabled in 1002. In particular, the UE may determine that UE-initiated PRACH for LTM is enabled.

In embodiments, the UE may further obtain a TA for a target cell associated with the LTM procedure. Further, the UE may receive a configurable parameter as part of an LTM configuration for a target cell associated with the LTM in some embodiments. The configurable parameter may indicate that the UE-initiated PRACH for LTM is enabled.

In some embodiments, the UE may further configure a PRACH resource for each candidate SSB of a target cell associated with the LTM procedure. The PRACH resource for each candidate SSB may be configured via RRC signaling in some embodiments. In some embodiments, the RRC signaling may include a PRACH resource configuration IE of the target cell, an SSB-perRACH-Occasion IE, and/or pairs of SSB and dedicated RACH resource indexes IE.

The procedure 1000 may include determining that the LTM procedure is to be triggered in 1004. In particular, the UE may determine that the LTM procedure is to be triggered based on one or more conditions being met.

In some embodiments, the one or more conditions may include a measurement result of a target cell associated with the LTM procedure being better than a measurement result of a serving cell associated with the LTM procedure and a difference of the measurement result of the target cell and the measurement result of the serving cell being equal to or larger than an offset value. In some embodiments, the offset value may be provided by RRC signaling.

In some embodiments, the one or more conditions may include a measured result of a serving cell associated with the LTM procedure being worse than a first threshold and at least one measured result associated with a target cell associated with the LTM procedure being better than a second threshold. Further, the UE may receive the first threshold and the second threshold via RRC signaling in some embodiments.

The procedure 1006 may include initiating a RACH procedure to trigger the LTM procedure in 1006. In particular, the UE may initiate a RACH procedure to trigger the LTM procedure based on the determination that the LTM procedure is to be triggered.

Although FIG. 10 may arguably imply an order of the operation of the procedure 1000, it should be understood that the operations may be performed in a different order and/or one or more of the operations may be concurrently performed in other embodiments. Further, it should be understood that one or more of the operations of the procedure 1000 may be omitted and/or one or more additional operations may be added to the procedure 1000 in other embodiments.

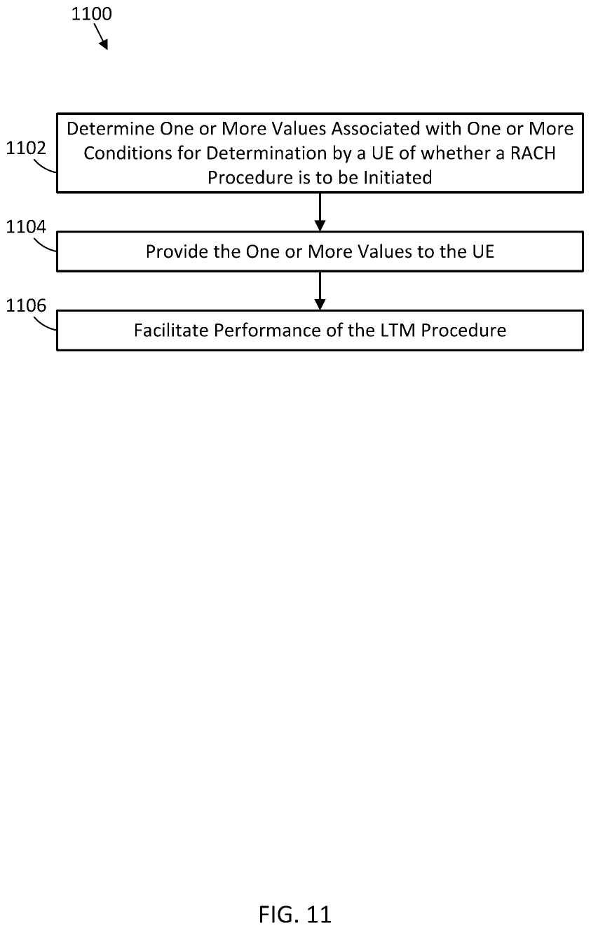

FIG. 11 illustrates an example procedure 1100 of operating a base station in accordance with some embodiments. The base station may include one or more of the features of the gNB 1400 (FIG. 14). The procedure 1100 may provide for UE-initiated RACH for an LTM procedure.

The procedure 1100 may include determining one or more values associated with one or more conditions for determination by a UE of whether a RACH procedure is to be initiated in 1102. In particular, the base station may determine one or more values associated with one or more conditions for determination by a UE of whether a RACH procedure is to be initiated to trigger an LTM procedure.

In some embodiments, the one or more values may include a measurement result associated with a target cell associated with the LTM procedure and a measurement result associated with a serving cell associated with the LTM procedure and an offset value to determine whether to initiate a RACH procedure based on the measurement result associated with the target cell and the measurement result associated with the serving cell. In some embodiments, the one or more conditions may include the measurement result associated with the target cell being better than the measurement result associated with the serving cell and a difference of the measurement result of the target cell and the measurement result of the serving cell is equal to or larger than the offset value.

In some embodiments, the one or more values may include a first threshold value associated with a serving cell associated with the LTM procedure and a second threshold value associated with a target cell associated with the LTM procedure. Further, the one or more conditions may include a measured result of the serving cell being worst than the first threshold value and at least one measured result associated with the target cell being better than the second threshold value in some embodiments.

The procedure 1100 may include providing the one or more values to the UE in 1104. In particular, the base station may provide the one or more values to the UE for the determination of whether the RACH procedure is to be initiated. In some embodiments, the one or more values may be provided to the UE via RRC signaling.

In some embodiments, the base station may further provide a configurable parameter to the UE as part of an LTM configuration for a target cell associated with the LTM procedure. The configurable parameter may be to indicate whether a UE-initiated PRACH for LTM is enabled.

In some embodiments, the base station may further configure a dedicated PRACH resource for each candidate SSB of a target cell associated with the LTM procedure. Further, the dedicated PRACH resource for each candidate SSB may be configured via RRC signaling in some embodiments. In some embodiments, the RRC signaling may include a PRACH resource configuration IE of the target cell, an SSB-perRACH-Occasion IE, and/or pairs of SSB and dedicated RACH resource indexes IE.

The procedure 1100 may include facilitating performance of the LTM procedure in 1106. In particular, the base station may facilitate performance of the LTM procedure based on initiation of the RACH procedure by the UE.

Although FIG. 11 may arguably imply an order of the operation of the procedure 1100, it should be understood that the operations may be performed in a different order and/or one or more of the operations may be concurrently performed in other embodiments. Further, it should be understood that one or more of the operations of the procedure 1100 may be omitted and/or one or more additional operations may be added to the procedure 1100 in other embodiments.

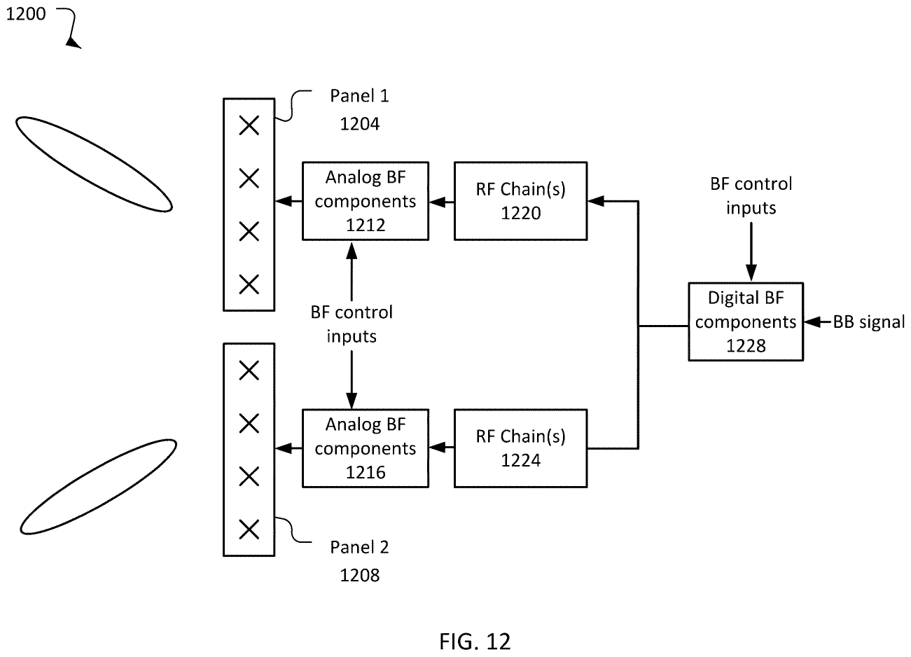

FIG. 12 illustrates example beamforming circuitry 1200 in accordance with some embodiments. The beamforming circuitry 1200 may include a first antenna panel, panel 1 1204, and a second antenna panel, panel 2 1208. Each antenna panel may include a number of antenna elements. Other embodiments may include other numbers of antenna panels.

Digital beamforming (BF) components 1228 may receive an input baseband (BB) signal from, for example, a baseband processor such as, for example, baseband processor 1304A of FIG. 13. The digital BF components 1228 may rely on complex weights to pre-code the BB signal and provide a beamformed BB signal to parallel radio frequency (RF) chains 1220/1224.

Each RF chain 1220/1224 may include a digital-to-analog converter to convert the BB signal into the analog domain; a mixer to mix the baseband signal to an RF signal; and a power amplifier to amplify the RF signal for transmission.

The RF signal may be provided to analog BF components 1212/1216, which may apply additionally beamforming by providing phase shifts in the analog domain. The RF signals may then be provided to antenna panels 1204/1208 for transmission.

In some embodiments, instead of the hybrid beamforming shown here, the beamforming may be done solely in the digital domain or solely in the analog domain.

In various embodiments, control circuitry, which may reside in a baseband processor, may provide BF weights to the analog/digital BF components to provide a transmit beam at respective antenna panels. These BF weights may be determined by the control circuitry to provide the directional provisioning of the serving cells as described herein. In some embodiments, the BF components and antenna panels may operate together to provide a dynamic phased-array that is capable of directing the beams in the desired direction.

FIG. 13 illustrates an example UE 1300 in accordance with some embodiments. The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1300 may be a RedCap UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, antenna structure 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein. The memory/storage 1312 include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1308 may include transceiver circuitry and radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, phased array antennas, etc. The antenna 1326 may have one or more panels designed for specific frequency bands including bands in FR1 or FR2.

In some embodiments, the UE 1300 may include the beamforming circuitry 1200 (FIG. 12), where the beamforming circuitry 1200 may be utilized for communication with the UE 1300. In some embodiments, components of the UE 1300 and the beamforming circuitry may be shared. For example, the antennas 1326 of the UE may include the panel 1 1204 and the panel 2 1208 of the beamforming circuitry 1200.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

FIG. 14 illustrates an example gNB 1400 in accordance with some embodiments. The gNB 1400 may include processors 1404, RF interface circuitry 1408, core network (CN) interface circuitry 1412, memory/storage circuitry 1416, and antenna structure 1426.

The components of the gNB 1400 may be coupled with various other components over one or more interconnects 1428.

The processors 1404, RF interface circuitry 1408, memory/storage circuitry 1416 (including communication protocol stack 1410), antenna structure 1426, and interconnects 1428 may be similar to like-named elements shown and described with respect to FIG. 13.

The CN interface circuitry 1412 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE) comprising determining an uplink (UL) transmission timing for a sounding reference signal (SRS) transmission to a base station of a target cell, the UE being served by a base station of a serving cell, and transmitting the SRS transmission to the base station of the target cell in accordance with the determined UL transmission timing for the SRS transmission.

Example 2 may include the method of example 1, wherein determining the UL transmission timing comprises determining a downlink (DL) timing obtained from a DL reference signal (RS) used for layer 1 (L1) channel state information (CSI) measurement, and transmitting the SRS transmission comprises transmitting the SRS transmission in accordance with the determined DL timing.

Example 3 may include the method of example 1, wherein determining the UL transmission timing for the SRS transmission comprises determining an offset value based on a downlink (DL) reception timing obtained from a DL reference signal (RS) used for layer 1 (L1) channel state information (CSI) measurement of the serving cell and a DL reception of the target cell, and transmitting the SRS transmission comprises transmitting the SRS transmission based on the offset value.

Example 4 may include the method of example 3, further comprising initiating a window starting from a last symbol of a measured reference signal (RS) resource, maintaining the determined offset value for a duration of the window, and removing the offset value after termination of the window.

Example 5 may include the method of example 1, further comprising configuring a non-serving cell-SRS resource set (N-SRS-RESET) associated with the target cell, wherein one or more resources used for SRS transmissions are configured within the N-SRS-RESET.

Example 6 may include the method of example 5, wherein the N-SRS-RESET is configured as part of a serving cell configuration.

Example 7 may include the method of example 6, wherein the N-SRS-RESET includes a physical cell identifier (ID) or an additional physical cell ID (PCI) index that identifies the target cell.

Example 8 may include the method of example 6, wherein the N-SRS-RESET indicates a center frequency of a synchronization signal block (SSB) and an ssb-PositionsInBurst field, a point A of the target cell to be utilized to derive SRS resource location in a frequency domain, a subcarrier spacing (SCS), or a system frame number (SFN) offset and a halfFrameIndex value.

Example 9 may include the method of example 5, wherein the N-SRS-RESET is configured as part of a non-serving cell configuration.

Example 10 may include the method of example 9, wherein the N-SRS-RESET is activated/deactivated by a medium access control (MAC)-control element (CE).

Example 11 may include the method of example 9, wherein a medium access control (MAC)-control element (CE) is used to map N-SRS-RESETs with a corresponding codepoint of an SRS request field in a downlink control information (DCI) format.

Example 12 may include the method of example 5, wherein the configuration of the N-SRS-RESET includes a PO parameter and a pathloss compensation factor (a) for the target cell.

Example 13 may include the method of example 5, further comprising receiving, via radio resource control (RRC) signaling, a synchronization signal block (SSB) index of the target cell or a channel state information (CSI)-reference signal (RS) for the N-SRS-RESET.

Example 14 may include the method of example 5, further comprising receiving, via an ss-PBCH-BlockPower information element (IE), synchronization signal block (SSB) transmission power for the target cell.

Example 15 may include the method of example 5, further comprising receiving a transmit power control (TPC)-command for the target cell for layer 1 (L1)/layer 2 (L2)-triggered mobility (LTM) within a downlink control information (DCI) format 2_3 transmission.

Example 16 may include the method of example 5, further comprising determining a spatial relation for N-SRS-RESET transmission based on SRS-SpatialRelationInfo for each N-SRS resource in the N-SRS-RESET.

Example 17 may include the method of example 5, further comprising determining a synchronization signal block (SSB) with a largest measured layer 1 (L1)-reference signal received power (RSRP) for a most recent channel state information (CSI) report associated with the target cell.

Example 18 may include the method of example 1, wherein the SRS transmission is triggered based on a physical cell identifier (ID) or an additional physical cell ID (PCI) index of the target cell for an SRS resource set for the target cell.

Example 19 may include the method of example 1, wherein the SRS transmission is triggered based on an additional physical cell identifier (PCI) index included in a downlink control information (DCI) format 0_1 in a UE specific search space (USS).

Example 20 may include the method of example 1, wherein the SRS transmission is triggered based on a medium access control (MAC)-control element (CE) to associate a codepoint of an aperiodicSRS-ResourceTrigger field and non-serving cell-SRS-resource sets (N-SRS-RESETs) for the target cell.

Example 21 may include a method of operating a user equipment (UE), comprising receiving a configuration for the N-SRS-RESET for the target cell, the UE being served by a serving cell, configuring the N-SRS-RESET in accordance with the received configuration, determining an uplink (UL) transmission timing for a sounding reference signal (SRS) transmission to a base station of the target cell, and transmitting the SRS transmission to the base station of the target cell in accordance with the determined UL transmission timing for the SRS transmission.

Example 22 may include the method of example 21, wherein determining the UL transmission timing comprises determining a downlink (DL) timing obtained from a DL reference signal (RS) used for layer 1 (L1) channel state information (CSI) measurement, and transmitting the SRS transmission comprises transmitting the SRS transmission in accordance with the determined UL transmission timing.

Example 23 may include the method of example 21, wherein determining the UL transmission timing comprises determining an offset value based on a downlink (DL) reception timing obtained from a DL reference signal (RS) used for layer 1 (L1) channel state information (CSI) measurement of the serving cell and a DL reception timing obtained from a DL RS used for L1 CSI measurement of the target cell, and transmitting the SRS transmission comprises transmitting the SRS transmission based on the determined offset value and a UL transmission timing of the serving cell.

Example 24 may include the method of example 23, further comprising initiating a window starting a last symbol of a measured reference signal (RS) resource, maintaining the determined offset value for a duration of the window, and removing the offset value after termination of the window.

Example 25 may include the method of example 21, wherein the N-SRS-RESET is configured as part of a serving cell configuration.

Example 26 may include the method of example 25, wherein the N-SRS-RESET includes a physical cell identifier (ID) or an additional physical cell ID (PCI) index that identifies the target cell.

Example 27 may include the method of example 25, wherein the N-SRS-RESET indicates a center frequency of a synchronization signal block (SSB) and an ssb-PositionsInBurst field, a point A of the target cell to be utilized to derive SRS resource location in a frequency domain, a subcarrier spacing (SCS), or a system frame number (SFN) offset and a halfFrameIndex value.

Example 28 may include the method of example 21, wherein the N-SRS-RESET is configured as part of a non-serving cell configuration.

Example 29 may include the method of example 28, wherein the N-SRS-RESET is activated/deactivated by a medium access control (MAC)-control element (CE).

Example 30 may include the method of example 28, wherein a medium access control (MAC)-control element (CE) is used to map N-SRS-RESETs with a corresponding codepoint of an SRS request field in a downlink control information (DCI) format.

Example 31 may include the method of example 21, wherein the configuration of the N-SRS-RESET includes a PO parameter and a pathloss compensation factor (a) for the target cell.

Example 32 may include the method of example 21, further comprising receiving, via radio resource control (RRC) signaling, a synchronization signal block (SSB) index of the target cell or a channel state information (CSI)-reference signal (RS) for the N-SRS-RESET.

Example 33 may include the method of example 21, further comprising receiving, via an ss-PBCH-BlockPower information element (IE), synchronization signal block (SSB) transmission power for the target cell.

Example 34 may include the method of example 21, further comprising receiving a transmit power control (TPC)-command for the target cell for layer 1 (L1)/layer 2 (L2)-triggered mobility (LTM) within a downlink control information (DCI) format 2_3 transmission.

Example 35 may include the method of example 21, further comprising determining a spatial relation for N-SRS-RESET transmission based on SRS-SpatialRelationInfo for each N-SRS resource in the N-SRS-RESET.

Example 36 may include the method of example 21, further comprising determining a synchronization signal block (SSB) with a largest measured layer 1 (L1)-reference signal received power (RSRP) for a most recent channel state information (CSI) report associated with the target cell.

Example 37 may include the method of example 21, wherein the SRS transmission is triggered based on a physical cell identifier (ID) or an additional physical cell ID (PCI) index of the target cell for an SRS resource set for the target cell.

Example 38 may include the method of example 21, wherein the SRS transmission is triggered based on an additional physical cell identifier (PCI) index included in a downlink control information (DCI) format 0_1 in a UE specific search space (USS).

Example 39 may include the method of example 21, wherein the SRS transmission is triggered based on a medium access control (MAC)-control element (CE) to associate a codepoint of an aperiodicSRS-ResourceTrigger field and non-serving cell-SRS-resource sets (N-SRS-RESETs) for the target cell.

Example 40 may include a method of operating a base station, comprising generating a configuration transmission with a configuration for a non-serving cell-sounding reference signal resource set (N-SRS-RESET), the N-SRS-RESET to define resources for transmission of sounding reference signal (SRS) transmissions, transmitting the configuration transmission to a user equipment (UE), the UE to determine a resource for transmission of an SRS to a target cell, and providing an SRS triggering to the UE to trigger transmission of the SRS by the UE.

Example 41 may include the method of example 40, further comprising transmitting a downlink (DL) reference signal (RS) to the UE, the DL RS to be utilized for determining DL timing, wherein the SRS is to be transmitted by the UE based on the determined DL timing.

Example 42 may include the method of example 40, wherein the base station is a first base station, wherein the first base station is associated with a first cell, and wherein the method further comprises transmitting a first synchronization signal block (SSB) to the UE, and wherein the UE is to determine an offset value for timing for transmission of the SRS based on a reception of the first SSB received from the first base station and a second SSB received from a second base station associated with a second cell.

Example 43 may include the method of example 42, further comprising configuring, via radio resource control (RRC) signaling or a system information block (SIB), a window for the UE, wherein the UE is to maintain the offset value for a duration of the window and remove the offset value based on termination of the window.

Example 44 may include the method of example 40, wherein the configuration transmission is transmitted as part of a serving cell configuration.

Example 45 may include the method of example 44, wherein the N-SRS-RESET includes a physical cell identifier information element or an additional physical cell ID (PCI) index information element that identifies the target cell for the transmission of the SRS by the UE.

Example 46 may include the method of example 44, wherein the N-SRS-RESET comprises a center frequency of synchronization signal block (SSB) and ssb-PositionsInBurst information element (IE), a point A of the target cell IE, the point A of the target cell IE used to derive an SRS resource location in a frequency domain, or a sequence frame number (SFN) offset and a halfFrameIndex value IE.

Example 47 may include the method of example 40, wherein the configuration transmission is transmitted as part of a non-serving cell configuration.

Example 48 may include the method of example 47, wherein the N-SRS-RESET is activated/deactivated a medium access control (MAC)-control element (CE).

Example 49 may include the method of example 47, wherein a medium access control (MAC)-control element (CE) is used to map N-SRS-RESETs with a codepoint of an SRS request field in a downlink control information (DCI) format.

Example 50 may include the method of example 40, wherein the configuration of the N-SRS-RESET comprises a PO parameter and a pathloss compensation factor (a) for the target cell.

Example 51 may include the method of example 40, further comprising transmitting, via radio resource control (RRC) signaling, a synchronization signal block (SSB) index of the target cell or a channel state information (CSI)-reference signal (RS) for the N-SRS-RESET.

Example 52 may include the method of example 40, further comprising transmitting, via an ss-PBCH-BlockPower information element (IE), synchronization signal block (SSB) transmission power for the target cell.

Example 53 may include the method of example 40, further comprising transmitting a transmit power control (TPC)-command for the target cell for layer 1 (L1)/layer 2 (L2)-triggered mobility (LTM) within a downlink control information (DCI) format 2_3 transmission.

Example 54 may include the method of example 40, further comprising transmitting SRS-SpatialRelationInfo for each N-SRS resource in the N-SRS-RESET to indicate a spatial relation for the N-SRS-RESET.

Example 55 may include the method of example 40, wherein the SRS triggering comprises a physical cell identifier (ID) or an additional physical cell ID (PCI) index of the target cell for the N-SRS-RESET.

Example 56 may include the method of example 40, wherein the SRS triggering comprises an additional physical cell identifier (PCI) index in a downlink control information (DCI) format 0_1 in a UE specific search space (USS).

Example 57 may include the method of example 40, wherein the SRS triggering comprises a medium access control (MAC)-control element (CE) to associate a codepoint of an aperiodicSRS-ResourceTrigger field and non-serving cell-SRS-resource sets (N-SRS-RESETs) for the target cell.

Example 58 may include a method of operating a user equipment (UE), comprising determining one or more conditions are met to trigger a layer 1 (L1)/layer 2 (L2)-triggered mobility (LTM) procedure, initiating a random access channel (RACH) procedure to trigger the LTM procedure based on the one or more conditions being met, and obtaining a timing advance for a target cell based on the one or more conditions being met.

Example 59 may include the method of example 58, wherein determining the one or more conditions are met comprises determining that a measurement result of the target cell is better than a measurement result of a serving cell and a difference of the measurement result of the target cell and the measurement result of the serving cell is equal to or larger than an offset value.

Example 60 may include the method of example 59, wherein the offset value is determined based on radio resource control (RRC) signaling.

Example 61 may include the method of example 58, further comprising receiving an indication of a first threshold value and a second threshold value, wherein determining the one or more conditions are met comprises determining that a measured result of a serving cell is worse than the first threshold value, and determining that at least one measured result of the target cell is better than the second threshold value.

Example 62 may include the method of example 61, wherein the indication of the first threshold value and the second threshold value is received via RRC signaling.

Example 63 may include the method of example 58, further comprising receiving an LTM configuration for the target cell, and determining that a UE-initiated physical random access channel (PRACH) for LTM is enabled based on a configurable parameter of the LTM configuration.

Example 64 may include the method of example 63, wherein the LTM configuration comprises a dedicated PRACH resource for each synchronization signal block (SSB) of the target cell.

Example 65 may include the method of example 64, wherein the dedicated PRACH resource for each SSB of the target cell is configured via radio resource control (RRC) signaling.

Example 66 may include the method of example 65, wherein the RRC signaling comprises a PRACH resource configuration information element (IE) of the target cell, an SSB-perRACH-Occasion IE, or pairs of SSB and dedicated RACH resource indexes IE.

Example 67 may include a method of operating a user equipment (UE), comprising determining that UE-initiated physical random access channel (PRACH) for LTM is enabled, determining that the LTM procedure is to be triggered based on the one or more conditions being met, and initiating a random access channel (RACH) procedure to trigger the LTM procedure based on the determination that the LTM procedure is to be triggered.

Example 68 may include the method of example 67, further comprising obtaining a timing advance (TA) for a target cell associated with the LTM procedure.

Example 69 may include the method of example 67, wherein the one or more conditions comprise a measurement result of a target cell associated with the LTM procedure being better than a measurement result of a serving cell associated with the LTM procedure and a difference of the measurement result of the target cell and the measurement result of the serving cell is equal to or larger than an offset value.

Example 70 may include the method of example 69, wherein the offset value is provided by radio resource control (RRC) signaling.

Example 71 may include the method of example 67, wherein the one or more conditions comprise a measured result of a serving cell associated with the LTM procedure being worse than a first threshold and at least one measured result associated with a target cell associated with the LTM procedure being better than a second threshold.

Example 72 may include the method of example 71, further comprising receiving the first threshold and the second threshold via radio resource control (RRC) signaling.

Example 73 may include the method of example 67, further comprising receiving a configurable parameter as part of an LTM configuration for a target cell associated with the LTM procedure, the configurable parameter indicating that the UE-initiated PRACH for LTM is enabled.

Example 74 may include the method of example 67, further comprising configuring a PRACH resource for each candidate synchronization signal block (SSB) of a target cell associated with the LTM procedure.

Example 75 may include the method of example 74, wherein the PRACH resource for each candidate SSB is configured via radio resource control (RRC) signaling.

Example 76 may include the method of example 75, wherein the RRC signaling comprises a PRACH resource configuration information element (IE) of the target cell, an SSB-perRACH-Occasion IE, or pairs of SSB and dedicated RACH resource indexes IE.

Example 77 may include a method of operating a base station, comprising determining one or more values associated with one or more conditions for determination by a user equipment (UE) of whether a random access channel (RACH) procedure is to be initiated to trigger a layer 1 (L1)/layer 2 (L2)-triggered mobility (LTM) procedure, providing the one or more values to the UE for the determination of whether the RACH procedure is to be initiated, and facilitating performance of the LTM procedure based on initiation of the RACH procedure by the UE.

Example 78 may include the method of example 77, wherein the one or more values are provided to the UE via radio resource control (RRC) signaling.

Example 79 may include the method of example 77, wherein the one or more values comprise a measurement result associated with a target cell associated with the LTM procedure and a measurement result associated with a serving cell associated with the LTM procedure and an offset value to determine whether to initiate a RACH procedure based on the measurement result associated with the target cell and the measurement result associated with the serving cell.

Example 80 may include the method of example 79, wherein the one or more conditions comprise the measurement result associated with the target cell being better than the measurement result associated with the serving cell and a different of the measurement result of the target cell and the measurement result of the serving cell is equal to or larger than the offset value.

Example 81 may include the method of example 77, wherein the one or more values comprise a first threshold value associated with a serving cell associated with the LTM procedure and a second threshold value associated with a target cell associated with the LTM procedure.

Example 82 may include the method of example 81, wherein the one or more conditions comprise a measured result of the serving cell being worse than the first threshold value and at least one measured result associated with the target cell being better than the second threshold value.

Example 83 may include the method of example 77, further comprising providing a configurable parameter to the UE as part of an LTM configuration for a target cell associated with the LTM procedure, the configurable parameter to indicate whether a UE-initiated physical random access channel (PRACH) for LTM is enabled.

Example 84 may include the method of example 77, further comprising configuring a dedicated physical random access channel (PRACH) resource for each candidate synchronization signal block (SSB) of a target cell associated with the LTM procedure.

Example 85 may include the method of example 84, wherein the dedicated PRACH resource for each candidate SSB is configured via radio resource control (RRC) signaling.

Example 86 may include the method of example 85, wherein the RRC signaling comprises a PRACH resource configuration information element (IE) of the target cell, an SSB-perRACH-Occasion IE, or pairs of SSB and dedicated RACH resource indexes IE.

Example 87 may include an apparatus comprising means to perform one or more elements of a method described in or related to any of examples 1-86, or any other method or process described herein.

Example 88 may include one or more non-transitory computer-readable media comprising instructions to cause an electronic device, upon execution of the instructions by one or more processors of the electronic device, to perform one or more elements of a method described in or related to any of examples 1-86, or any other method or process described herein.

Example 89 may include an apparatus comprising logic, modules, or circuitry to perform one or more elements of a method described in or related to any of examples 1-86, or any other method or process described herein.

Example 90 may include a method, technique, or process as described in or related to any of examples 1-86, or portions or parts thereof.

Example 91 may include an apparatus comprising: one or more processors and one or more computer-readable media comprising instructions that, when executed by the one or more processors, cause the one or more processors to perform the method, techniques, or process as described in or related to any of examples 1-86, or portions thereof.

Example 92 may include a signal as described in or related to any of examples 1-86, or portions or parts thereof.

Example 93 may include a datagram, information element, packet, frame, segment, PDU, or message as described in or related to any of examples 1-86, or portions or parts thereof, or otherwise described in the present disclosure.

Example 94 may include a signal encoded with data as described in or related to any of examples 1-86, or portions or parts thereof, or otherwise described in the present disclosure.

Example 95 may include a signal encoded with a datagram, IE, packet, frame, segment, PDU, or message as described in or related to any of examples 1-86, or portions or parts thereof, or otherwise described in the present disclosure.

Example 96 may include an electromagnetic signal carrying computer-readable instructions, wherein execution of the computer-readable instructions by one or more processors is to cause the one or more processors to perform the method, techniques, or process as described in or related to any of examples 1-86, or portions thereof.

Example 97 may include a computer program comprising instructions, wherein execution of the program by a processing element is to cause the processing element to carry out the method, techniques, or process as described in or related to any of examples 1-86, or portions thereof.

Example 98 may include a signal in a wireless network as shown and described herein.

Example 99 may include a method of communicating in a wireless network as shown and described herein.

Example 100 may include a system for providing wireless communication as shown and described herein.

Example 101 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method comprising:
identifying that at least one condition is met to trigger a layer 1 (L1) or layer 2 (L2)-triggered mobility (LTM) procedure;
initiating a random access channel (RACH) procedure to trigger the LTM procedure based on the at least one condition being met; and
obtaining a timing advance for a target cell based on the at least one condition being met.

22. The method of claim 21, wherein identifying that the at least one condition is met comprises identifying that a measurement result of the target cell is better than a measurement result of a serving cell and a difference of the measurement result of the target cell and the measurement result of the serving cell is equal to or larger than an offset value.

23. The method of claim 22, wherein the offset value is determined based on radio resource control (RRC) signaling.

24. The method of claim 21, further comprising receiving an indication of a first threshold value and a second threshold value, wherein identifying that the at least one condition is met comprises:
identifying that a measured result of a serving cell is worse than the first threshold value; and
identifying that at least one measured result of the target cell is better than the second threshold value.

25. The method of claim 24, wherein the indication of the first threshold value and the second threshold value is received via RRC signaling.

26. The method of claim 21, further comprising:
receiving an LTM configuration for the target cell; and
identifying that a UE-initiated physical random access channel (PRACH) for LTM is enabled based on a configurable parameter of the LTM configuration.

27. The method of claim 26, wherein the LTM configuration comprises a dedicated PRACH resource for each synchronization signal block (SSB) of the target cell.

28. An apparatus, comprising:
processing circuitry to:
identify that UE-initiated physical random access channel (PRACH) for layer 1 (L1) or layer 2 (L2)-triggered mobility (LTM) is enabled;
identify that an LTM procedure is to be triggered based on at least one condition being met; and
initiate a random access channel (RACH) procedure to trigger the LTM procedure based on the identification that the LTM procedure is to be triggered; and
interface circuitry coupled with the processing circuitry, the interface circuitry to enable communication.

29. The apparatus of claim 28, wherein the processing circuitry is further to:
obtain a timing advance (TA) for a target cell associated with the LTM procedure.

30. The apparatus of claim 28, wherein the at least one condition comprises a measurement result of a target cell associated with the LTM procedure being better than a measurement result of a serving cell associated with the LTM procedure and a difference of the measurement result of the target cell and the measurement result of the serving cell is equal to or larger than an offset value.

31. The apparatus of claim 28, wherein the at least one condition comprises a measured result of a serving cell associated with the LTM procedure being worse than a first threshold and at least one measured result associated with a target cell associated with the LTM procedure being better than a second threshold.

32. The apparatus of claim 28, wherein the processing circuitry is further to receive a configurable parameter as part of an LTM configuration for a target cell associated with the LTM procedure, the configurable parameter indicating that the UE-initiated PRACH for LTM is enabled.

33. The apparatus of claim 28, wherein the processing circuitry is further to receive a configuration information element to configure a PRACH resource for each candidate synchronization signal block (SSB) of a target cell associated with the LTM procedure.

34. The apparatus of claim 33, wherein the PRACH resource for each candidate SSB is configured via radio resource control (RRC) signaling.

35. A method, comprising:
identifying at least one value associated with at least one condition for determination by a user equipment (UE) of whether a random access channel (RACH) procedure is to be initiated to trigger a layer 1 (L1)/layer 2 (L2)-triggered mobility (LTM) procedure;
generating, for transmission to the UE, a signal with the at least one value for the determination of whether the RACH procedure is to be initiated; and
facilitating performance of the LTM procedure based on initiation of the RACH procedure by the UE.

36. The method of claim 35, wherein the at least one value is transmitted to the UE via radio resource control (RRC) signaling.

37. The method of claim 35, wherein the at least one value comprises a measurement result associated with a target cell associated with the LTM procedure and a measurement result associated with a serving cell associated with the LTM procedure and an offset value to determine whether to initiate the RACH procedure based on the measurement result associated with the target cell and the measurement result associated with the serving cell.

38. The method of claim 35, wherein the at least one value comprises a first threshold value associated with a serving cell associated with the LTM procedure and a second threshold value associated with a target cell associated with the LTM procedure.

39. The method of claim 35, further comprising:
generating, for transmission to the UE, a configurable parameter as part of an LTM configuration for a target cell associated with the LTM procedure, the configurable parameter to indicate whether a UE-initiated physical random access channel (PRACH) for LTM is enabled.

40. The method of claim 35, further comprising:
generating, for transmission, a configuration for a dedicated physical random access channel (PRACH) resource for each candidate synchronization signal block (SSB) of a target cell associated with the LTM procedure.
